(19) United States
(12) Patent Application Publication
(10) Pub. No.: US 2023/0404153 A1
(43) Pub. Date: Dec. 21, 2023

(54) AEROSOL-GENERATING DEVICE WITH HEATER WITH COLD ZONE

(71) Applicant: Philip Morris Products S.A., Neuchatel (CH)

(72) Inventors: Michel BESSANT, Neuchâtel (CH); Marine JARRIAULT, Neuchâtel (CH); Frédéric LAVANCHY, Neuchâtel (CH); Silviu Natanael PANTEA, Neuchâtel (CH); Johannes Petrus Maria PIJNENBURG, Neuchâtel (CH); Jun Wei YIM, Neuchâtel (CH); Grégori ISCHI, Neuchâtel (CH)

(73) Assignee: Philip Morris Products S.A., Neuchatel (CH)

(21) Appl. No.: 18/250,303

(22) PCT Filed: Oct. 25, 2021
(86) PCT No.: PCT/EP2021/079554

§ 371 Date: Apr. 24, 2023

(30) Foreign Application Priority Data
Oct. 28, 2020 (EP) 20204491.3

(51) Int. Cl. A24F 40/46; A24F 40/20; A24D 1/20; H05B 3/34

(52) U.S. Cl. CPC A24F 40/46; A24F 40/20; A24D 1/20; H05B 3/34

(57) ABSTRACT

A heater assembly for an aerosol-generating device is provided, including: an elongate heating chamber configured to heat an aerosol-forming substrate; and a heating element arranged around the elongate heating chamber, the elongate heating chamber having a first length and the heating element having a second length, the first length of the elongate heating chamber being greater than the second length of the heating element, such that there is a proximal distance between a proximal end of the elongate heating chamber and a proximal end of the heating element, and the proximal distance being between 0.1 millimeter and 4 millimeters. An aerosol-generating device including the heater assembly, and an aerosol-generating system including the aerosol-generating device and an aerosol-generating article, are also provided.

The present disclosure relates to a heater assembly for an aerosol-generating device. The present disclosure further relates to an aerosol-generating device. The present disclosure further relates to an aerosol-generating system comprising an aerosol-generating device and an aerosol-forming substrate.

It is known to provide an aerosol-generating device for generating an inhalable vapor. Such devices may heat an aerosol-forming substrate contained in an aerosol-generating article without burning the aerosol-forming substrate. The aerosol-generating article may have a rod shape for insertion of the aerosol-generating article into a heating chamber of the aerosol-generating device. A heating element is typically arranged in or around the heating chamber for heating the aerosol-forming substrate once the aerosol-generating article is inserted into the heating chamber of the aerosol-generating device.

Heat produced by the heating element may inadvertently be dissipated away from the heating chamber. Heat may be dissipated to the environment or to other components of the aerosol-generating system. Heat may inadvertently be dissipated away from the heating chamber via free air convection. Heat may inadvertently be dissipated away from the heating chamber by heat conduction via components of the aerosol-generating device. Heat may inadvertently be dissipated away from the heating chamber by heat conduction via components of the aerosol-generating article, for example via the aerosol-forming substrate. Heat dissipation away from the heating chamber may cause heating of components of the device that are not intended to be heated. For example, a housing of the device to be grasped by a user may become uncomfortably hot. Heat dissipation away from the heating chamber may cause heat losses within the heating chamber. Heat losses within the heating chamber may result in a less efficient heating. An excess amount of energy may be required to heat the heating chamber to a desired temperature.

The aerosol-generating article may comprise a substrate portion and a neighboring filter portion. The substrate portion may be located at the distal end of the article and may comprise the aerosol-forming substrate. The filter portion may be located at the proximal end of the article and may comprise a mouthpiece filter, for example a cellulose acetate filter. If, during use, too much heat is dissipated from the heated substrate portion towards the mouthpiece filter, potentially harmful components may be generated within the mouthpiece filter. If, during use, large proximal parts of the substrate portion are not sufficiently heated, an aerosol generated in a distal part of the substrate portion may inadvertently condense within the cold proximal part of the substrate portion before reaching a user's mouth.

It would be desirable to have an aerosol-generating device that may reduce heating of portions of an aerosol-generating article other than the substrate portion. It would be desirable to have an aerosol-generating device that may avoid substantial amounts of aerosol to condense in a proximal part of the substrate portion.

It would further be desirable to have an aerosol-generating device that may reduce heat losses from the heating chamber. It would be desirable to thermally insulate the heating chamber with respect to other components of the aerosol-generating device. It would be desirable to have an aerosol-generating device that may reduce heating up of the outer housing of the device to be grasped by a user.

According to an embodiment of the invention there is provided a heater assembly for an aerosol-generating device. The heater assembly may comprise an elongate heating chamber for heating an aerosol-forming substrate. The heater assembly may further comprise a heating element arranged around the heating chamber. The heating chamber may have a first length and the heating element may have a second length. The length of the heating chamber may be greater than the length of the heating element, such that there is a proximal distance between a proximal end of the heating chamber and a proximal end of the heating element.

According to an embodiment of the invention there is provided a heater assembly for an aerosol-generating device. The heater assembly comprises an elongate heating chamber for heating an aerosol-forming substrate. The heater assembly further comprises a heating element arranged around the heating chamber. The heating chamber has a first length and the heating element has a second length. The length of the heating chamber is greater than the length of the heating element, such that there is a proximal distance between a proximal end of the heating chamber and a proximal end of the heating element.

By providing the proximal distance, during use, the proximal end of the heating chamber may be heated to lower temperatures than other parts of the heating chamber which are surrounded by the heating element. For example, the proximal end of the heating chamber may be heated to lower temperatures in comparison to a longitudinally centered region of the heating chamber. A proximal “cold zone” of the heating chamber may be provided between the proximal end of the heating element and the proximal end of heating chamber. During use, the temperature in the cold zone may be below the temperature in the longitudinal center of the heating chamber. During use, the temperature in the cold zone may be significantly above the temperature outside the heating chamber because of heat transfer within the heating chamber.

The temperature in the longitudinal center of the cold zone may be between 25 percent and 95 percent of the temperature in the longitudinal center of the heating chamber. The temperature in the longitudinal center of the cold zone may be between 30 percent and percent of the temperature in the longitudinal center of the heating chamber. The temperature in the longitudinal center of the cold zone may be between 35 percent and 50 percent of the temperature in the longitudinal center of the heating chamber. The temperature in the longitudinal center of the cold zone may be about 45 percent of the temperature in the longitudinal center of the heating chamber. The maximum temperature in the heating chamber may be between 240° C. and 280° C., preferably 260° C. The coldest point in the cold zone may be between 45° C. and 85° C., preferably 65° C.

When an aerosol-forming substrate is inserted into the heating chamber, a proximal part of the aerosol-forming substrate may be located in the cold zone. The proximal part of the aerosol-forming substrate located in the cold zone may be heated sufficiently such that condensation of aerosol in the proximal part of the aerosol-forming substrate may be reduced or avoided. The proximal part of the aerosol-forming substrate located in the cold zone may be heated to a lower temperature than a distal part of the aerosol-forming substrate such that inadvertent excess heating of components located adjacent the proximal end of the aerosol-forming substrate may be reduced or avoided.

The aerosol-forming substrate may be a substrate portion of an aerosol-generating article. By the proximal distance, heating of portions of the aerosol-generating article other than the substrate portion may be reduced or avoided. Inadvertent heating of a mouthpiece of an aerosol-generating article may be reduced or avoided.

By providing the proximal distance, during use, a proximal end of the heating chamber may become less hot. There may be less thermal losses from a less hot proximal end of the heating chamber to one or both of the environment and other components of the aerosol-generating device or system. By the proximal distance, thermal insulation of the heating chamber with respect to other components of the aerosol-generating device or system may be improved. By the proximal distance, an aerosol-generating device may be provided that reduces heating up of the outer housing of the device to be grasped by a user.

The proximal distance may be between 0.1 millimeter and 4 millimeters, preferably between 0.5 millimeter and 4 millimeters, more preferably between 1 millimeter and 3 millimeters, more preferably between 1.5 millimeters and 2.5 millimeters, and most preferably about 2 millimeters. These distances may be sufficiently long to beneficially reduce heat losses and generation of potentially harmful constituents in the cold zone. At the same time, these distances may still be sufficiently small such that aerosol-forming substrate located in the cold zone may still be heated sufficiently to reduce or avoid condensation of aerosol in the proximal part of the aerosol-forming substrate located in the cold zone.

An inner diameter of the heating chamber may be defined in a direction orthogonal to a longitudinal axis of the heating chamber. The inner diameter of the heating chamber may be between 4 millimeters and 9 millimeters, preferably between 4.5 millimeters and 8 millimeters. The inner diameter of the heating chamber may be between 4.5 millimeters and 6.3 millimeters, more preferably between 5.2 millimeters and 5.5 millimeters, and most preferably about 5.35 millimeters. The inner diameter of the heating chamber may be between 6.8 millimeters and 7.5 millimeters, preferably between 7.2 millimeters and 7.4 millimeters, more preferably about 7.3 millimeters or 7.35 millimeters.

The length of the heating chamber may be measured along the longitudinal axis of the heating chamber. The length of the heating chamber may be between 10 millimeters and millimeters, preferably between 18 millimeters and 26 millimeters, more preferably between 20 millimeters and 24 millimeters, and most preferably about 22 millimeters. The length of the heating chamber may be between 10 millimeters and 14 millimeters, preferably between 11 millimeters and 13 millimeters, more preferably about 12 millimeters.

The length of the heating element may be measured in a direction parallel to the longitudinal axis of the heating chamber. The length of the heating element may be between millimeters and 21 millimeters, preferably between 17 millimeters and 18 millimeters, and more preferably about 17 millimeters. The length of the heating element may be between 10 millimeters and 13 millimeters, preferably about 11 millimeters.

The heater assembly may comprise a distal distance between a distal end of the heating chamber and a distal end of the heating element.

By providing the distal distance, during use, a distal end of the heating chamber may become less hot. There may be less thermal losses from a colder distal end to one or both of the environment and other components of the aerosol-generating device. By the distal distance, heat losses from the heating chamber may be reduced. By the distal distance, thermal insulation of the heating chamber with respect to other components of the aerosol-generating device may be improved. By the distal distance, an aerosol-generating device may be provided that reduces heating up of the outer housing of the device to be grasped by a user.

The distal distance may be between 1 millimeter and 6 millimeters, preferably between 1.5 millimeters and 6 millimeters, more preferably between 2 millimeters and 4 millimeters, more preferably between 2.5 millimeters and 3.5 millimeters, and most preferably about 3 millimeters. The distal distance may be about 1 millimeter.

According to an embodiment, the length of the heating chamber is 22 millimeters, the inner diameter of the heating chamber is 5.35 millimeters, the length of the heating element is 17 millimeters, the proximal distance is 2 millimeters, and the distal distance is 3 millimeters. According to an embodiment, the length of the heating chamber is between 19 millimeters and 22 millimeters, the inner diameter of the heating chamber is 5.35 millimeters, the length of the heating element is between 17 millimeters and 20 millimeters, and the proximal distance is 2 millimeters.

According to an embodiment, the length of the heating chamber is 12 millimeters, the inner diameter of the heating chamber is between 7.0 millimeters and 7.35 millimeters, the length of the heating element is 10 millimeters, the proximal distance is 1 millimeter, and the distal distance is 1 millimeter. According to an embodiment, the length of the heating chamber is between 11 millimeters and 12 millimeters, the inner diameter of the heating chamber is between 7.0 millimeters and 7.35 millimeters, the length of the heating element is between 10 millimeters and 11 millimeters, and the proximal distance is 1 millimeter.

As used herein, the terms “upstream” and “front”, and “downstream” and “rear”, are used to describe the relative positions of components, or portions of components, of the aerosol-generating device in relation to the direction in which airflows through the aerosol-generating device during use thereof. Aerosol-generating devices according to the invention comprise a proximal end through which, in use, an aerosol exits the device. The proximal end of the aerosol-generating device may also be referred to as the mouth end or the downstream end. The mouth end is downstream of the distal end. The distal end of the aerosol-generating article may also be referred to as the upstream end. Components, or portions of components, of the aerosol-generating device may be described as being upstream or downstream of one another based on their relative positions with respect to the airflow path of the aerosol-generating device.

A proximal end of the heater assembly according to the invention is configured to be arranged within an aerosol-generating device in a direction towards the mouth end or downstream end of the device. A distal end of the heater assembly according to the invention is configured to be arranged within an aerosol-generating device in a direction towards the distal end or upstream end of the device. A longitudinal axis of the heating chamber may extend between the proximal end of the heating chamber and the distal end of the heating chamber. A longitudinal axis of the heating chamber may extend between the proximal end of the heater assembly and the distal end of the heater assembly.

The proximal distance may be measured in a direction parallel to the longitudinal axis of the heating chamber. The distal distance may be measured in a direction parallel to the longitudinal axis of the heating chamber.

The heater assembly may comprise a heater casing. The heater casing may comprise a wall of the heater casing. The heater casing may be arranged around the heating chamber. The heater casing may be arranged radially distanced from the heating chamber. The heater assembly may further comprise a first connecting wall. The heater assembly may further comprise a second connecting wall. The heater assembly may further comprise an air-tight hollow space. The air-tight hollow space may be defined between the heating chamber, the heater casing, and the first and second connecting walls. The heating chamber may comprise a wall of the heating chamber. Each of the first and second connecting walls may extent between the wall of the heating chamber and the wall of the heater casing. The first and second connecting walls may sealingly connect the heater casing with the outer wall of the heating chamber. The connecting walls may be oriented perpendicular to the longitudinal axis of the heating chamber. The first connecting wall may be a proximal connecting wall. The second connecting wall may be a distal connecting wall.

The heating chamber may be configured for receiving an aerosol-forming substrate. The heating chamber may comprise a cavity into which the aerosol-forming substrate may be inserted. The aerosol-forming substrate may be part of an aerosol-generating article. The heating chamber may comprise an opening at a proximal end of the heating chamber for receiving the aerosol-forming substrate. The opening may also serve as an air outlet. The heating chamber may comprise an air inlet at a distal end of the heating chamber.

The heating chamber may have an elongate shape. A longitudinal axis of the heating chamber may extend between the proximal end and the distal end of the heating chamber.

The heating chamber may be a hollow tube. The hollow tube may be formed from a wall of the heating chamber. The wall of the heating chamber may comprise or may be made a metal or an alloy. The wall of the heating chamber may comprise or may be made of stainless steel.

The heating element may be arranged at least partly around the wall of the heating chamber. Preferably, the heating element is arranged fully coaxially surrounding the outer perimeter of the wall of the heating chamber. The heating element may be arranged along at least a part of the longitudinal axis of the heating chamber.

The heating chamber may comprise a central region comprising the heating element. The term central region refers to the longitudinal direction. The heating chamber may further comprise a proximal region and a distal region. One or both of the proximal region and the distal region may be distanced from the heating element in a longitudinal direction by one or both of a respective proximal distance and a respective distal distance. A proximal cold zone may be defined by the proximal distance. A distal cold zone may be defined by the distal distance. During use, one or both of the proximal cold zone and the distal cold zone may be colder than the central region of the heating chamber. The first and second connecting walls may contact the heating chamber in the proximal and distal cold zones, respectively. The first and second connecting walls may thus contact the heating chamber at the coldest points of the heating chamber during use. Thereby, heat losses from the heating chamber to the connecting walls and the heater casing may be additionally reduced. Thermal insulation may be additionally improved.

The wall of the heating chamber may be made of stainless steel. This may beneficially enhance the effect that, during use, the proximal cold zone and the distal cold zone may be colder than the central region of the heating chamber.

The heating element may comprise one or more electrically conductive tracks on an electrically insulating substrate. The one or more electrically conductive tracks may be resistive heating tracks. The one or more electrically conductive tracks may be configured as a susceptor to be inductively heated. The electrically insulating substrate may be a flexible substrate.

The heating element may be flexible and may be wrapped around the heating chamber. The heating element may be arranged between the heating chamber and the heater casing.

In all of the aspects of the disclosure, the heating element may comprise an electrically resistive material. Suitable electrically resistive materials include but are not limited to: semiconductors such as doped ceramics, electrically “conductive” ceramics (such as, for example, molybdenum disilicide), carbon, graphite, metals, metal alloys and composite materials made of a ceramic material and a metallic material. Such composite materials may comprise doped or undoped ceramics.

As described, in any of the aspects of the disclosure, the heating element may be part of the heating chamber of the heater assembly for an aerosol-generating device. The heater assembly may comprise an internal heating element or an external heating element, or both internal and external heating elements, where “internal” and “external” refer to the aerosol-forming substrate. An internal heating element may take any suitable form. For example, an internal heating element may take the form of a heating blade. Alternatively, the internal heater may take the form of a casing or substrate having different electro-conductive portions, or an electrically resistive metallic tube. Alternatively, the internal heating element may be one or more heating needles or rods that run through the center of the aerosol-forming substrate. Other alternatives include a heating wire or filament, for example a Ni—Cr (Nickel-Chromium), platinum, tungsten or alloy wire or a heating plate. Optionally, the internal heating element may be deposited in or on a rigid carrier material. In one such embodiment, the electrically resistive heating element may be formed using a metal having a defined relationship between temperature and resistivity. In such an exemplary device, the metal may be formed as a track on a suitable insulating material, such as ceramic material, and then sandwiched in another insulating material, such as a glass. Heaters formed in this manner may be used to both heat and monitor the temperature of the heating elements during operation.

An external heating element may take any suitable form. For example, an external heating element may take the form of one or more flexible heating foils on a dielectric substrate, such as polyimide. The flexible heating foils can be shaped to conform to the perimeter of the substrate receiving cavity. Alternatively, an external heating element may take the form of a metallic grid or grids, a flexible printed circuit board, a molded interconnect device (MID), ceramic heater, flexible carbon fibre heater or may be formed using a coating technique, such as plasma vapour deposition, on a suitable shaped substrate. An external heating element may also be formed using a metal having a defined relationship between temperature and resistivity. In such an exemplary device, the metal may be formed as a track between two layers of suitable insulating materials. An external heating element formed in this manner may be used to both heat and monitor the temperature of the external heating element during operation.

The heating element advantageously heats the aerosol-forming substrate by means of heat conduction. The heating element may be at least partially in contact with the substrate, or the carrier on which the substrate is deposited. Alternatively, the heat from either an internal or external heating element may be conducted to the substrate by means of a heat conductive element.

During operation, the aerosol-forming substrate may be completely contained within the aerosol-generating device. In that case, a user may puff on a mouthpiece of the aerosol-generating device. Alternatively, during operation, a smoking article containing the aerosol-forming substrate may be partially contained within the aerosol-generating device. In that case, the user may puff directly on the smoking article.

The heating element may be configured as an induction heating element. The induction heating element may comprise an induction coil and a susceptor. In general, a susceptor is a material that is capable of generating heat, when penetrated by an alternating magnetic field. According to the invention, the susceptor may be electrically conductive or magnetic or both electrically conductive and magnetic. An alternating magnetic field generated by one or several induction coils heat the susceptor, which then transfers the heat to the aerosol-forming substrate, such that an aerosol is formed. The heat transfer may be mainly by conduction of heat. Such a transfer of heat is best, if the susceptor is in close thermal contact with the aerosol-forming substrate. When an induction heating element is employed, the induction heating element may be configured as an internal heating element as described herein or as an external heater as described herein. If the induction heating element is configured as an internal heating element, the susceptor element is preferably configured as a pin or blade for penetrating the aerosol-generating article. If the induction heating element is configured as an external heating element, the susceptor element is preferably configured as a cylindrical susceptor at least partly surrounding the cavity or forming the sidewall of the cavity.

The invention further relates to an aerosol-generating device comprising the heater assembly as described herein.

Preferably, the aerosol-generating device comprises a power supply configured to supply power to the heating element. The power supply preferably comprises a power source. Preferably, the power source is a battery, such as a lithium ion battery. As an alternative, the power source may be another form of charge storage device such as a capacitor. The power source may require recharging. For example, the power source may have sufficient capacity to allow for the continuous generation of aerosol for a period of around six minutes or for a period that is a multiple of six minutes. In another example, the power source may have sufficient capacity to allow for a predetermined number of puffs or discrete activations of the heater assembly.

The power supply may comprise control electronics. The control electronics may comprise a microcontroller. The microcontroller is preferably a programmable microcontroller. The electric circuitry may comprise further electronic components. The electric circuitry may be configured to regulate a supply of power to the heater assembly. Power may be supplied to the heater assembly continuously following activation of the system or may be supplied intermittently, such as on a puff-by-puff basis. The power may be supplied to the heater assembly in the form of pulses of electrical current.

The invention further relates to an aerosol-generating system comprising the aerosol-generating device as described herein and an aerosol-forming substrate configured to be at least partly inserted into the heating chamber. The aerosol-forming substrate may be part of an aerosol-generating article and the aerosol-generating article may be configured to be at least partly inserted into the heating chamber.

The aerosol-generating article may comprise a substrate portion comprising the aerosol-forming substrate. A length of the substrate portion may be shorter than or equal to a length of the heating element. A length of the substrate portion may be greater than a length of the heating element. A length of the substrate portion may be greater than a length of the heating element but shorter than a length of the heating chamber. A length of the substrate portion may be equal to or greater than a length of the heating chamber.

Generally, in an aerosol-generating system as described herein the proximal cold zone may extend between the proximal end of the heating element and the proximal end of the substrate portion when the aerosol-generating article is fully inserted into the heating chamber. The proximal end of the heating element may be arranged distal to the proximal end of the substrate portion when the aerosol-generating article is fully inserted into the heating chamber. The proximal end of the heating chamber may be arranged at the same longitudinal position as the proximal end of the substrate portion when the aerosol-generating article is fully inserted into the heating chamber. In that case, the proximal distance may be equal to the proximal cold zone. The proximal end of the heating chamber may be arranged distal to the proximal end of the substrate portion when the aerosol-generating article is fully inserted into the heating chamber.

The length of the substrate portion may be equal to the length of the heating chamber and the proximal distance may be equal to the proximal cold zone. If the length of the substrate portion is greater than the length of the heating chamber, then, the proximal cold zone may be longer than the proximal distance. In that case, the length of the proximal cold zone may be the sum of the proximal distance plus the additional distance between the proximal end of the heating chamber and the proximal end of the substrate portion.

If the length of the substrate portion is shorter than the length of the heating chamber, then, the proximal distance may be longer than the proximal cold zone.

According to an embodiment, the outer diameter of the aerosol-generating article is millimeters and the length of the proximal cold zone is between 0.1 millimeter and 4 millimeters, preferably between 0.5 millimeter and 4 millimeters, more preferably between 1 millimeter and 3 millimeters, more preferably between 1.5 millimeters and 2.5 millimeters, and most preferably about 2 millimeters.

According to an embodiment, the outer diameter of the aerosol-generating article is between 7.0 millimeters and 7.3 millimeters and the length of the proximal cold zone is between 0.1 millimeter and 2 millimeters, preferably between 0.5 millimeter and 1.5 millimeters, more preferably about 1 millimeter.

The length of the substrate portion may be between 10 millimeters and 35 millimeters, preferably between 18 millimeters and 26 millimeters, more preferably between millimeters and 24 millimeters, and most preferably about 22 millimeters. The outer diameter of the aerosol-generating article may be between 4 millimeters and 8 millimeters, preferably about 5.3 millimeters.

According to an embodiment, the length of the heating chamber is 22 millimeters, the inner diameter of the heating chamber is 5.35 millimeters, the length of the heating element is 17 millimeters, the proximal distance is 2 millimeters, and the distal distance is 3 millimeters, the outer diameter of the aerosol-generating article is 5.3 millimeters, and the length of the substrate portion is between 20 millimeters and 24 millimeters, preferably 22 millimeters.

The length of the substrate portion may be between 10 millimeters and 14 millimeters, preferably between 11 millimeters and 13 millimeters, more preferably about 12 millimeters. The outer diameter of the aerosol-generating article may be between 7 millimeters and 8 millimeters, preferably between 7.0 millimeters and 7.3 millimeters, more preferably about 7.23 millimeters.

According to an embodiment, the length of the heating chamber is 12 millimeters, the inner diameter of the heating chamber is about 7.3 millimeters, the length of the heating element is 10 millimeters, the proximal distance is 1 millimeter, the distal distance is 1 millimeter, the outer diameter of the aerosol-generating article is 7.23 millimeters, and the length of the substrate portion is between 11 millimeters and 13 millimeters, preferably 12 millimeters.

In an embodiment, the outer diameter of the aerosol-generating article is 5.3 millimeters, the length of the substrate portion is 20 millimeters, the inner diameter of the heating chamber is 5.35 millimeters, the length of the heating element is between 75 percent and 95 percent of the length of the substrate portion, the length of the proximal cold zone is between greater than 0 percent and 20 percent of the length of the substrate portion, and the length of the distal cold zone is between 5 percent and 15 percent of the length of the substrate portion.

In an embodiment, the outer diameter of the aerosol-generating article is 5.3 millimeters, the length of the substrate portion is 22 millimeters, the inner diameter of the heating chamber is 5.35 millimeters, the length of the heating element is between 68 percent and 95 percent, preferably about 77 percent, of the length of the substrate portion, the length of the proximal cold zone is between greater than 0 percent and 18 percent, preferably about 9 percent, of the length of the substrate portion, and the length of the distal cold zone is between 4.5 percent and 14 percent, preferably about 13.6 percent, of the length of the substrate portion.

In an embodiment, the outer diameter of the aerosol-generating article is 5.3 millimeters, the length of the substrate portion is 24 millimeters, the inner diameter of the heating chamber is 5.35 millimeters, the length of the heating element is between 62 percent and 88 percent of the length of the substrate portion, the length of the proximal cold zone is between greater than 0 percent and 17 percent, preferably about 8 percent, of the length of the substrate portion, and the length of the distal cold zone may be between 4 percent and 13 percent of the length of the substrate portion.

In an embodiment, the outer diameter of the aerosol-generating article between 7.0 millimeters and 7.3 millimeters, the length of the substrate portion is 12 millimeters, the inner diameter of the heating chamber is between 7.0 millimeters and 7.4 millimeters, the length of the heating element is between 67 percent and 92 percent of the length of the substrate portion, the length of the proximal cold zone is between greater than 0 percent and 17 percent, preferably about 8.3 percent, of the length of the substrate portion, and the length of the distal cold zone is between 8 percent and 17 percent of the length of the substrate portion.

The invention further relates to an aerosol-generating article for an aerosol-generating device. The aerosol-generating article may be an aerosol-generating article as described herein. The aerosol-generating article may be adapted for use with an aerosol-generating device as described herein.

As used herein, the term “aerosol-forming substrate” refers to a substrate capable of releasing volatile compounds that can form an aerosol. The volatile compounds may be released by heating or combusting the aerosol-forming substrate. As an alternative to heating or combustion, in some cases, volatile compounds may be released by a chemical reaction or by a mechanical stimulus, such as ultrasound. The aerosol-forming substrate may be solid or liquid or may comprise both solid and liquid components. An aerosol-forming substrate may be part of an aerosol-generating article.

As used herein, the term “aerosol-generating article” refers to an article comprising an aerosol-forming substrate that is capable of releasing volatile compounds that can form an aerosol. An aerosol-generating article may be disposable.

As used herein, the term “aerosol-generating device” refers to a device that interacts with an aerosol-forming substrate to generate an aerosol. An aerosol-generating device may interact with one or both of an aerosol-generating article comprising an aerosol-forming substrate, and a cartridge comprising an aerosol-forming substrate. In some examples, the aerosol-generating device may heat the aerosol-forming substrate to facilitate release of volatile compounds from the substrate. An electrically operated aerosol-generating device may comprise an atomiser, such as an electric heater, to heat the aerosol-forming substrate to form an aerosol.

As used herein, the term “aerosol-generating system” refers to the combination of an aerosol-generating device with an aerosol-forming substrate. When the aerosol-forming substrate forms part of an aerosol-generating article, the aerosol-generating system refers to the combination of the aerosol-generating device with the aerosol-generating article. In the aerosol-generating system, the aerosol-forming substrate and the aerosol-generating device cooperate to generate an aerosol.

Below, there is provided a non-exhaustive list of non-limiting examples. Any one or more of the features of these examples may be combined with any one or more features of another example, embodiment, or aspect described herein.

Example A: A heater assembly for an aerosol-generating device, comprising
an elongate heating chamber for heating an aerosol-forming substrate; and
a heating element arranged around the heating chamber; wherein the heating chamber has a first length and the heating element has a second length, and
wherein the length of the heating chamber is greater than the length of the heating element, such that there is a proximal distance between a proximal end of the heating chamber and a proximal end of the heating element.

Example B: The heater assembly according to Example A, wherein the proximal distance is between 0.1 millimeter and 4 millimeters, preferably between 1 millimeter and 3 millimeters, more preferably between 1.5 millimeters and 2.5 millimeters, and most preferably about 2 millimeters.

Example C: The heater assembly according to Example A or Example B, wherein a ratio of an inner diameter of the heating chamber to the proximal distance is between 2 and 4, preferably between 2.25 and 3.15, more preferably between 2.60 and 2.75, and most preferably about 2.68.

Example D: The heater assembly according to any of the preceding examples, wherein a ratio of a length of the heating chamber to the proximal distance is between 5.5 and 22, preferably between 9 and 13, more preferably about 11.

Example E: The heater assembly according to any of the preceding examples, wherein the proximal distance is between 6 percent and 14 percent, preferably between 8 percent and 11 percent, more preferably about 9 percent of the length of the heating chamber.

Example F: The heater assembly according to any of the preceding examples, wherein the length of the heating chamber is between 10 millimeters and 35 millimeters, preferably between 18 millimeters and 26 millimeters, more preferably between 20 millimeters and 24 millimeters, and most preferably about 22 millimeters.

Example G: The heater assembly according to any of the preceding examples, wherein the length of the heating element is between 15 millimeters and 21 millimeters, preferably between 17 millimeters and 18 millimeters, more preferably about 17 millimeters.

Example H: The heater assembly according to any of the preceding examples, wherein the inner diameter of the heating chamber is between 4.5 millimeters and 6.3 millimeters, preferably between 5.2 millimeters and 5.5 millimeters, more preferably about millimeters, or wherein the inner diameter of the heating chamber is between 6.8 millimeters and 7.5 millimeters, preferably between 7.2 millimeters and 7.4 millimeters, more preferably about 7.3 millimeters or 7.35 millimeters.

Example I: The heater assembly according to any of the preceding examples, wherein there is a distal distance between a distal end of the heating chamber and a distal end of the heating element.

Example J: The heater assembly according to Example I, wherein the distal distance is between 1 millimeter and 6 millimeters, preferably between 2 millimeters and 4 millimeters, more preferably between 2.5 millimeters and 3.5 millimeters, and most preferably about 3 millimeters.

Example K: The heater assembly according to Example I or Example J, wherein a ratio of an inner diameter of the heating chamber to the distal distance is between 1 and 3, preferably between 1.5 and 2.1, more preferably between 1.73 and 1.83, and most preferably about 1.78.

Example L: The heater assembly according to any of Examples I to K, wherein a ratio of a length of the heating chamber to the distal distance is between 5 and 11, preferably between 6 and 9, more preferably about 7.3.

Example M: The heater assembly according to any of Examples I to L, wherein the distal distance is between 9 percent and 20 percent, preferably between 12 percent and 15 percent, more preferably about 13.6 percent of the length of the heating chamber.

Example N: The heater assembly according to any of the preceding examples, wherein the heating chamber is a hollow tube.

Example O: The heater assembly according to any of the preceding examples, wherein the heating chamber comprises stainless steel.

Example P: The heater assembly according to any of the preceding examples, wherein the heating element comprises one or more electrically conductive tracks on an electrically insulating substrate.

Example Q: The heater assembly according to Example P, wherein the heating element is flexible and is wrapped around the heating chamber.

Example R: An aerosol-generating device comprising the heater assembly according to any of the preceding examples.

Example S: An aerosol-generating system comprising the aerosol-generating device according to Example R and an aerosol-forming substrate configured to be at least partly inserted into the heating chamber.

Example T: The aerosol-generating system according to Example S, wherein the system comprises an aerosol-generating article comprising a substrate portion comprising the aerosol-forming substrate, and wherein the aerosol-generating article is configured to be at least partly inserted into the heating chamber.

Example U: The aerosol-generating system according to Example T, wherein a length of the substrate portion is greater than a length of the heating element.

Example V: The aerosol-generating system according to Example U, wherein a length of the substrate portion is equal to or greater than a length of the heating chamber.

Example W: The aerosol-generating system according to any of Examples T to V, wherein the length of the substrate portion is between 15 millimeters and 35 millimeters, preferably between 18 millimeters and 26 millimeters, more preferably between 20 millimeters and 24 millimeters, and most preferably about 22 millimeters.

Example X: The aerosol-generating system according to any of Examples T to W, wherein the outer diameter of the aerosol-generating article is between 4 millimeters and 6 millimeters, preferably about 5.3 millimeters.

Features described in relation to one embodiment may equally be applied to other embodiments of the invention.

The invention will be further described, by way of example only, with reference to the accompanying drawings in which:

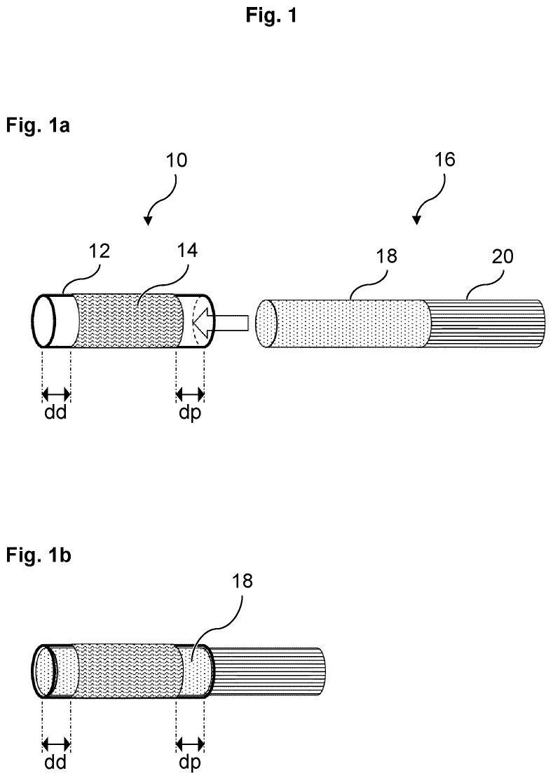

FIGS. 1a and 1b show a heater assembly in conjunction with an aerosol-generating article.

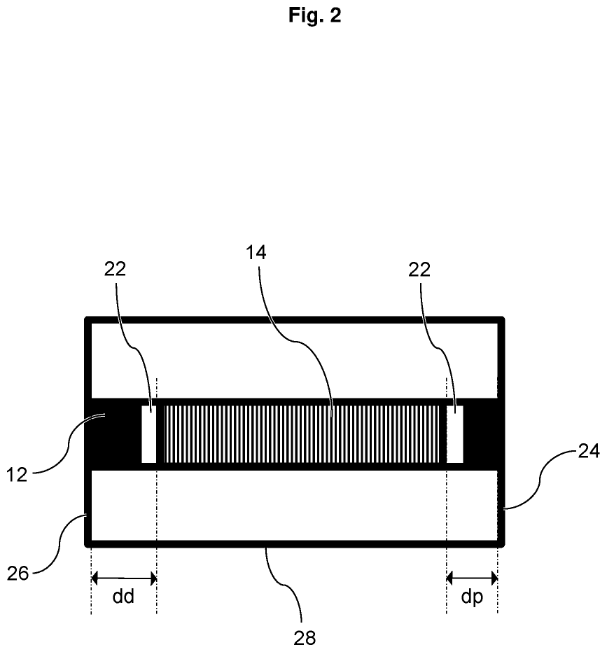

FIG. 2 shows a heater assembly.

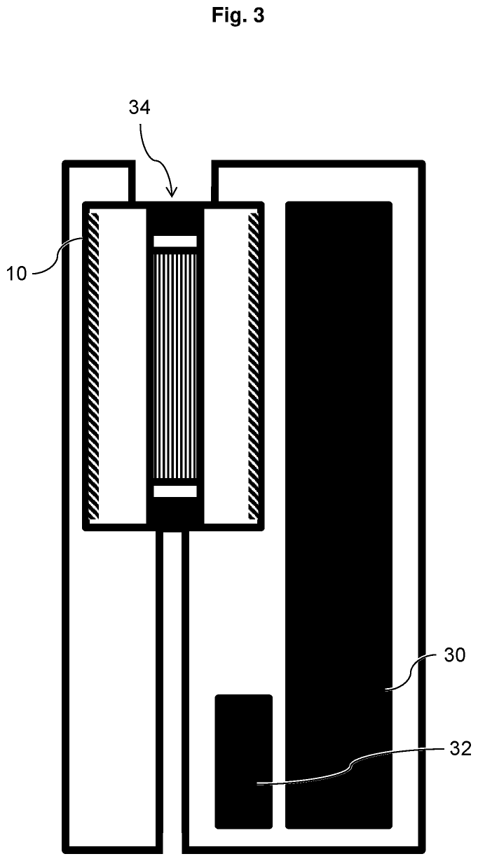

FIG. 3 shows an aerosol-generating device.

FIGS. 1a and 1b show an embodiment of a heater assembly 10. The heater assembly comprises an elongate heating chamber 12 for heating an aerosol-forming substrate and a heating element 14 arranged around the heating chamber 12. The length of the heating chamber 12 is greater than the length of the heating element 14, such that there is a proximal distance dp between a proximal end of the heating chamber 12 and a proximal end of the heating element 14.

The aerosol-generating substrate may be part of an aerosol-generating article 16 as shown in FIGS. 1a and 1b. The aerosol-generating article 16 comprises a substrate portion 18 comprising the aerosol-forming substrate and a mouthpiece 20. The heating chamber 12 is configured for receiving the aerosol-forming substrate as indicated by an arrow in FIG. 1a. FIG. 1b shows a configuration where the substrate portion 18 of the aerosol-generating article 16 is inserted into the heating chamber 12. FIG. 1b shows an embodiment where the length of the substrate portion 18 is equal to the length of the heating chamber 12. Thus, the proximal cold zone extending from the proximal end of the heating element 14 to the proximal end of the substrate portion 18 is equal to the proximal distance dp.

In the embodiment of FIGS. 1a and 1b, there also is a distal distance dd between a distal end of the heating chamber 12 and a distal end of the heating element 14. In the embodiment of FIGS. 1a and 1b, the proximal distance and the distal distance are approximately equal in length. In other embodiments, the proximal distance and the distal distance may differ in length, or there may be no distal distance.

FIG. 2 shows an embodiment of a heating heater assembly 10. The heating chamber 12 comprises a central region comprising a heating element 14. The heating element 14 is arranged around the heating chamber 12. The wall of the heating chamber 12 is a metal tube. The heating element 14 is flexible and is wrapped around the metal tube. The heating element 14 comprises electrically conductive heating tracks. The electrically conductive heating tracks may be act as a resistive heating element or they may act as a susceptor being inductively heated. The electrically conductive heating tracks are provided on an electrically insulating flexible substrate 22. In the embodiment shown, proximal and distal edge portions of the flexible substrate 22 are not covered by the electrically conductive heating tracks. In other embodiments, different regions or even the whole surface of the flexible substrate 22 may be covered by the heating tracks. The length of the heating element and the proximal and distal ends of the heating element refer to the length of the electrically conductive heating tracks and the proximal and distal ends of the electrically conductive heating tracks, respectively.

A proximal region and a distal region of the heating chamber 12 are distanced from the heating element 14 in a longitudinal direction. There is a proximal distance dp between a proximal end of the heating chamber 12 and a proximal end of the heating element 14. There is a distal distance dd between a distal end of the heating chamber 12 and a distal end of the heating element 14. In the embodiment of FIG. 2, the proximal distance dp is smaller in length than the distal distance dd.

The heating element 14 is arranged between the heating chamber 12 and a heater casing of the heater assembly 10. First and second connecting walls 24, 26 sealingly connect a wall of the heater casing 28 with the wall of the heating chamber 12.

The first and second connecting walls 24, 26 contact the heating chamber 12 in the proximal and distal regions, respectively. The first and second connecting walls 24, 26 contact the heating chamber 12 at positions distanced from the heating element 14. The first and second connecting walls 24, 26 thus contact the heating chamber 12 at the coldest points of the heating chamber 12 when being heated during use. Thereby, heat losses due to heat transport from the heating chamber 12 to the connecting walls 24, 26 and the heater casing via thermal conduction are additionally reduced. Thermal insulation may be additionally improved.

FIG. 3 shows an embodiment of an aerosol-generating device comprising the heater assembly 10 of FIG. 2. The aerosol-generating device further comprises a power supply. The power supply comprises a power source 30 and control electronics 32. The power source 30 may be a rechargeable battery. At opening 34, the aerosol-forming substrate may be inserted at least partly into the heating chamber 12.

1.-28. (canceled)

29. A heater assembly for an aerosol-generating device, comprising:
an elongate heating chamber configured to heat an aerosol-forming substrate; and
a heating element arranged around the elongate heating chamber,
wherein the elongate heating chamber has a first length and the heating element has a second length,
wherein the first length of the elongate heating chamber is greater than the second length of the heating element, such that there is a proximal distance between a proximal end of the elongate heating chamber and a proximal end of the heating element, and
wherein the proximal distance is between 0.1 millimeter and 4 millimeters.

30. The heater assembly according to claim 29, wherein the proximal distance is between 1 millimeter and 3 millimeters.

31. The heater assembly according to claim 29, wherein the proximal distance is about 2 millimeters.

32. The heater assembly according to claim 29, wherein a ratio of an inner diameter of the elongate heating chamber to the proximal distance is between 2 and 4.

33. The heater assembly according to claim 29, wherein a ratio of an inner diameter of the elongate heating chamber to the proximal distance is about 2.68.

34. The heater assembly according to claim 29, wherein a ratio of a length of the elongate heating chamber to the proximal distance is between 5.5 and 22.

35. The heater assembly according to claim 29, wherein a ratio of a length of the elongate heating chamber to the proximal distance is about 11.

36. The heater assembly according to claim 29, wherein the proximal distance is between 6 percent and 14 percent of a length of the elongate heating chamber.

37. The heater assembly according to claim 29, wherein the proximal distance is about 9 percent of a length of the elongate heating chamber.

38. The heater assembly according to claim 29, wherein there is a distal distance between a distal end of the elongate heating chamber and a distal end of the heating element.

39. The heater assembly according to claim 38, wherein the distal distance is between 1 millimeter and 6 millimeters.

40. The heater assembly according to claim 38, wherein the distal distance is about 3 millimeters.

41. The heater assembly according to claim 29, wherein the elongate heating chamber is a hollow tube.

42. The heater assembly according to claim 29, wherein the elongate heating chamber comprises stainless steel.

43. The heater assembly according to claim 29, wherein the heating element comprises one or more electrically conductive tracks on an electrically insulating substrate.

44. The heater assembly according to claim 29, wherein the heating element is flexible and is wrapped around the elongate heating chamber.

45. An aerosol-generating device comprising the heater assembly according to claim 29.

46. An aerosol-generating system comprising an aerosol-generating device according to claim 45 and an aerosol-generating article comprising a substrate portion comprising an aerosol-forming substrate, wherein the aerosol-generating article is configured to be at least partly inserted into the elongate heating chamber.

47. The aerosol-generating system according to claim 46, wherein a proximal cold zone extends between the proximal end of the heating element and a proximal end of the substrate portion when the aerosol-generating article is fully inserted into the elongate heating chamber.

48. The aerosol-generating system according to claim 46, wherein a length of the substrate portion is greater than a length of the heating element.
